(19) United States
(12) Patent Application Publication
(10) Pub. No.: US 2015/0334924 A1
(43) Pub. Date: Nov. 26, 2015

(54) Rootless Pot

(71) Applicant: Galina Valkova Medeiros, Panama City Beach, FL (US)

(72) Inventor: Galina Valkova Medeiros, Panama City Beach, FL (US)

(73) Assignee: Galina Valkova Medeiros, Panama City Beach, FL (US)

(21) Appl. No.: 14/720,890

(22) Filed: May 25, 2015

(51) Int. Cl. A01G 9/02

(52) U.S. Cl. CPC A01G 9/02

(57) ABSTRACT

ROOTLESS POT (RP); (ROOTLESS), is a multiple application, vegetation housing structure in a single and/or multi chambered, manufactured and/or artisan crafted, geometrical and/or free form tubular based shape bottomless pot and/or vase and/or planter.

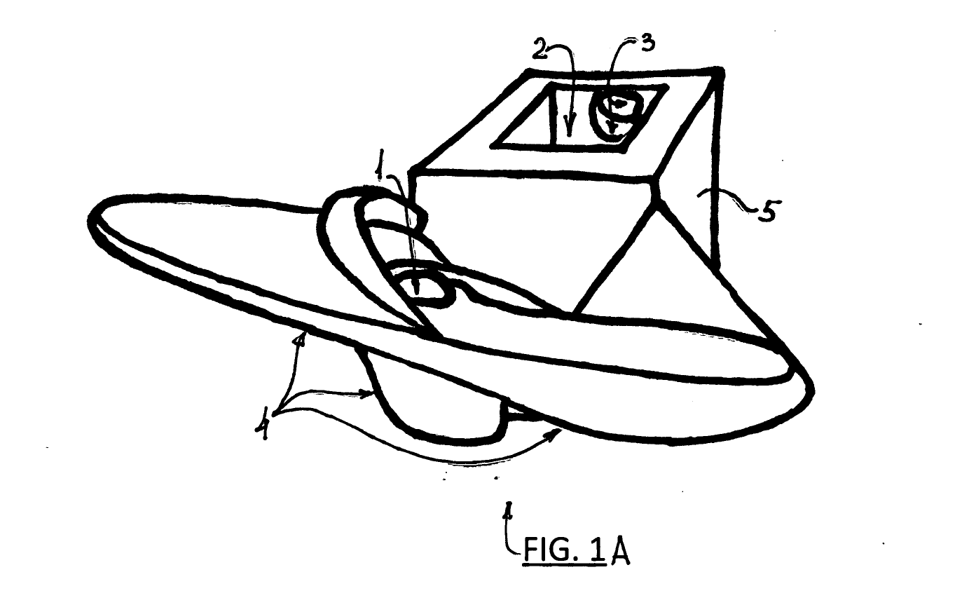

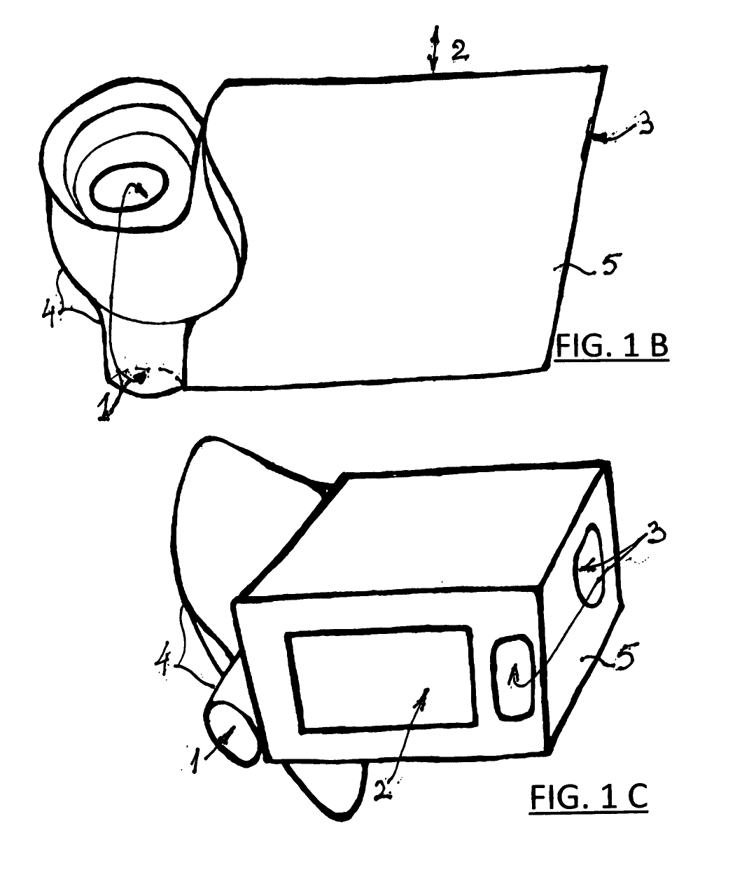

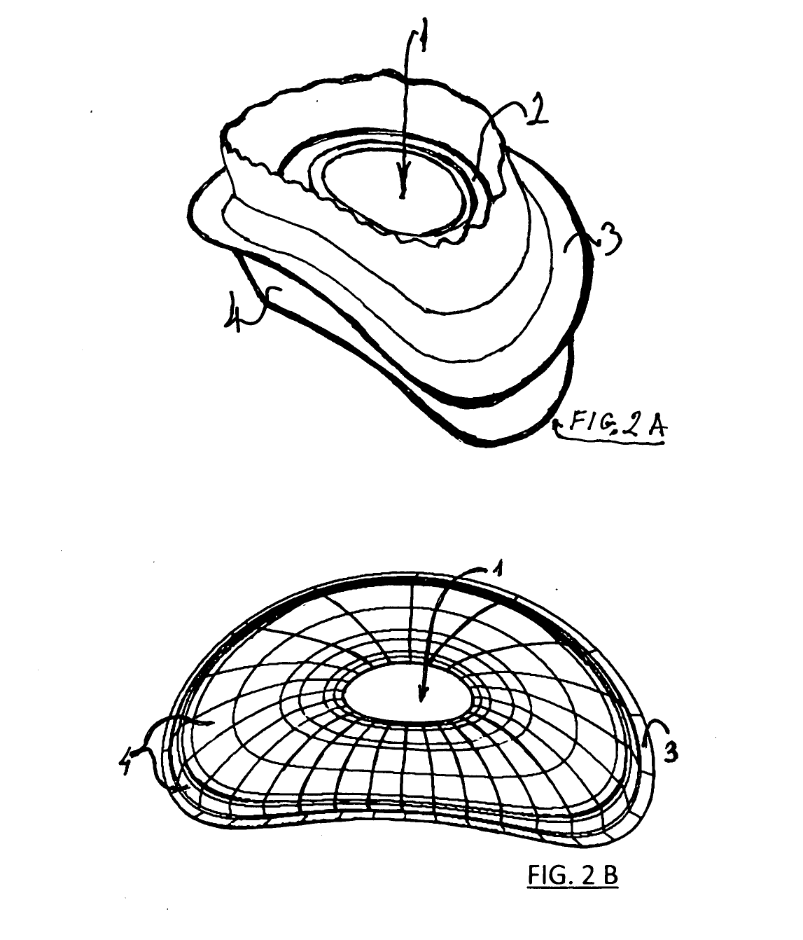

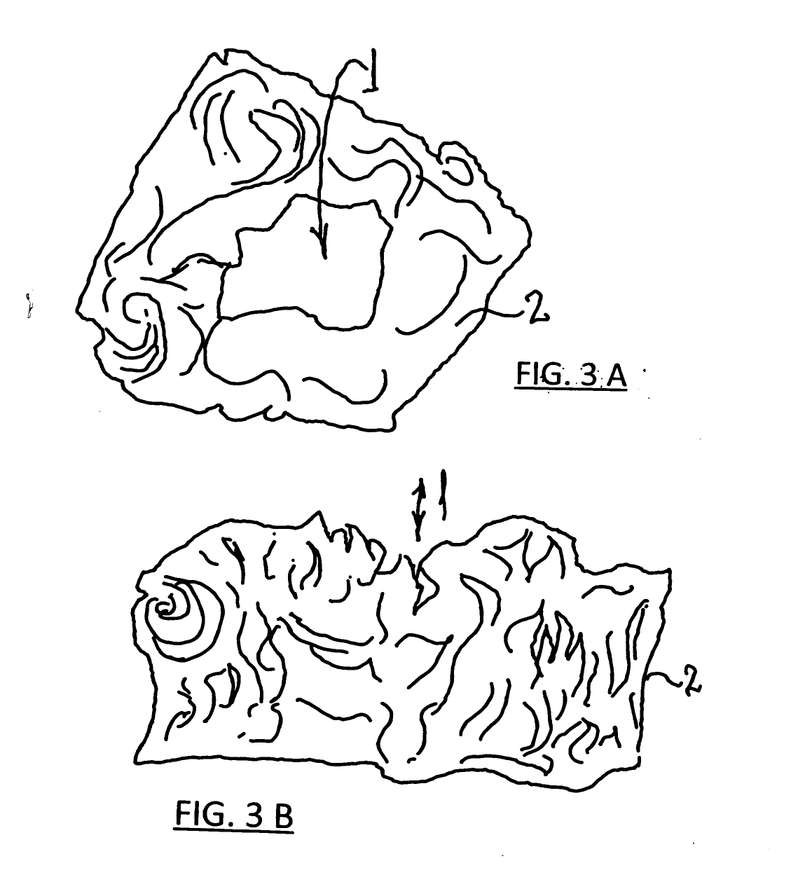

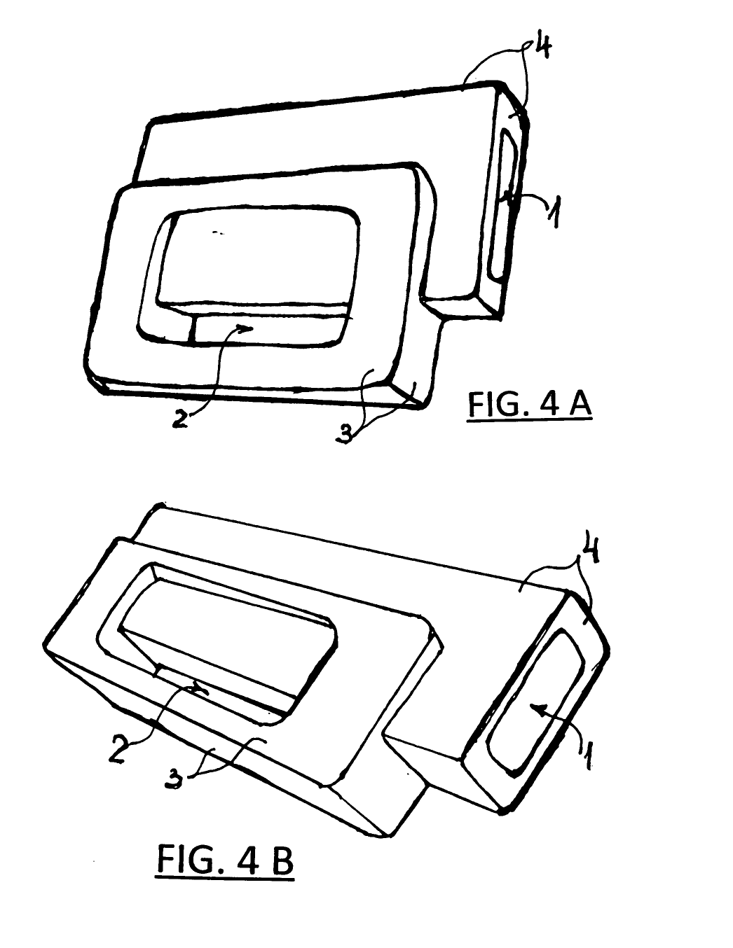

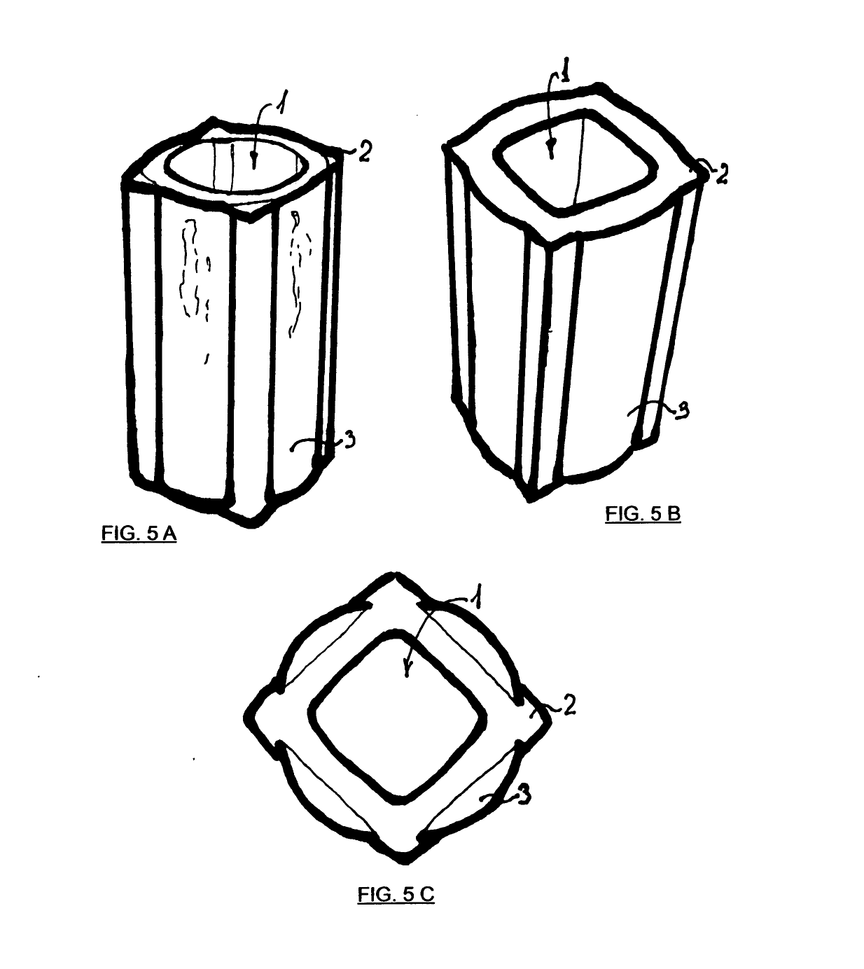

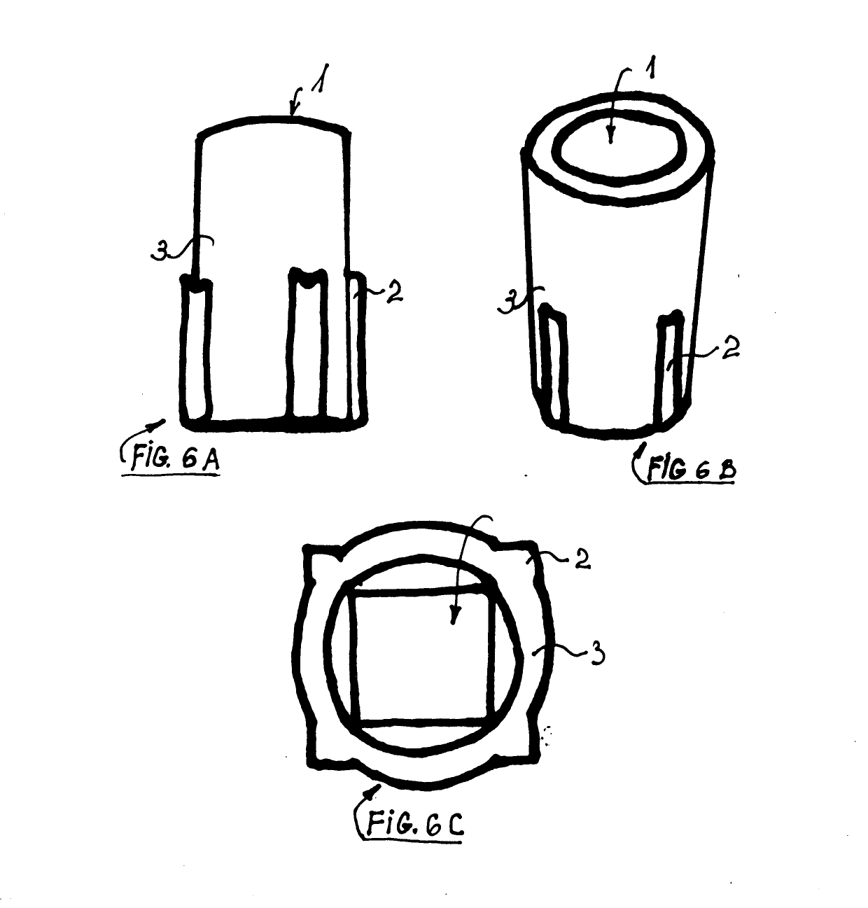

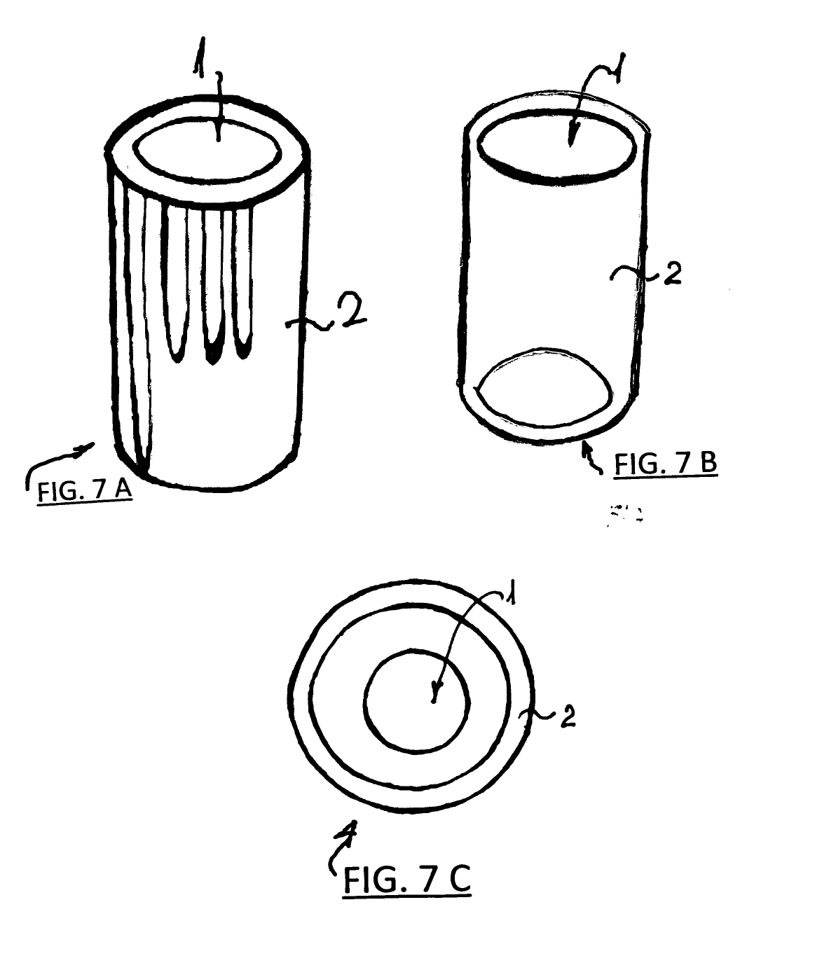

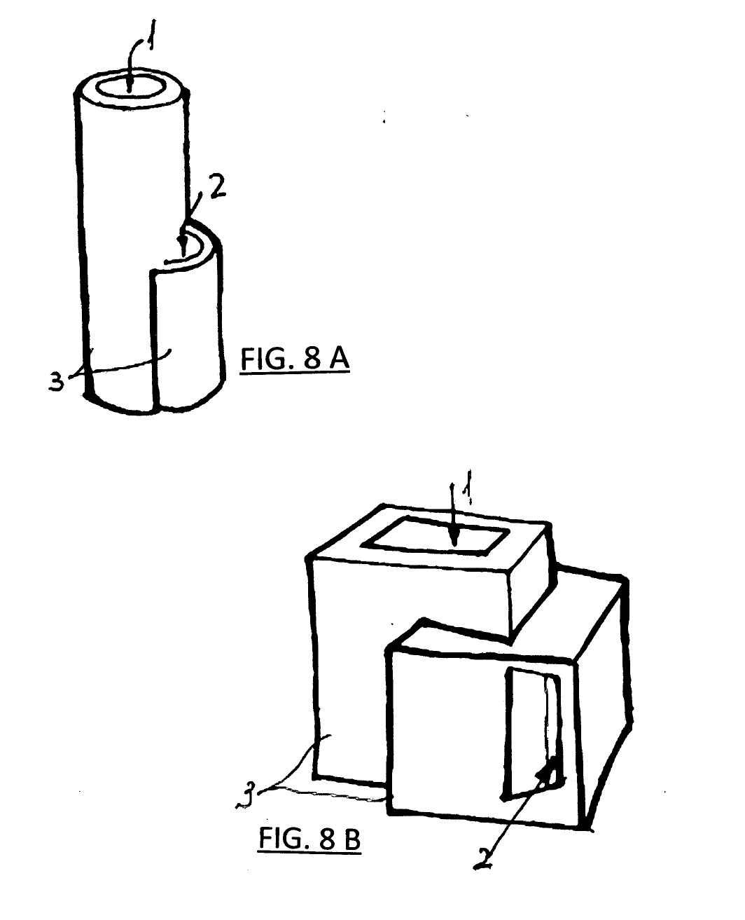

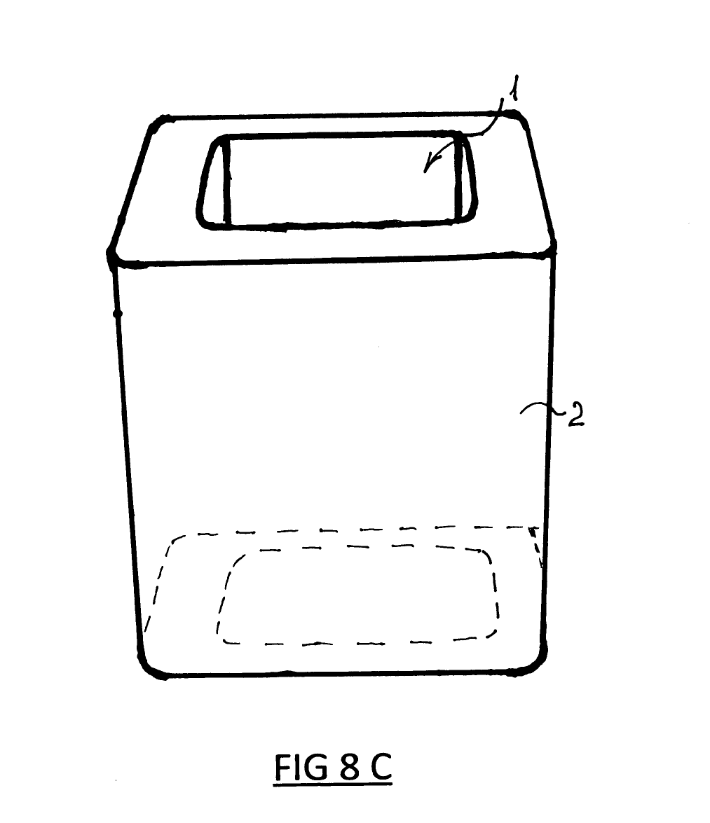

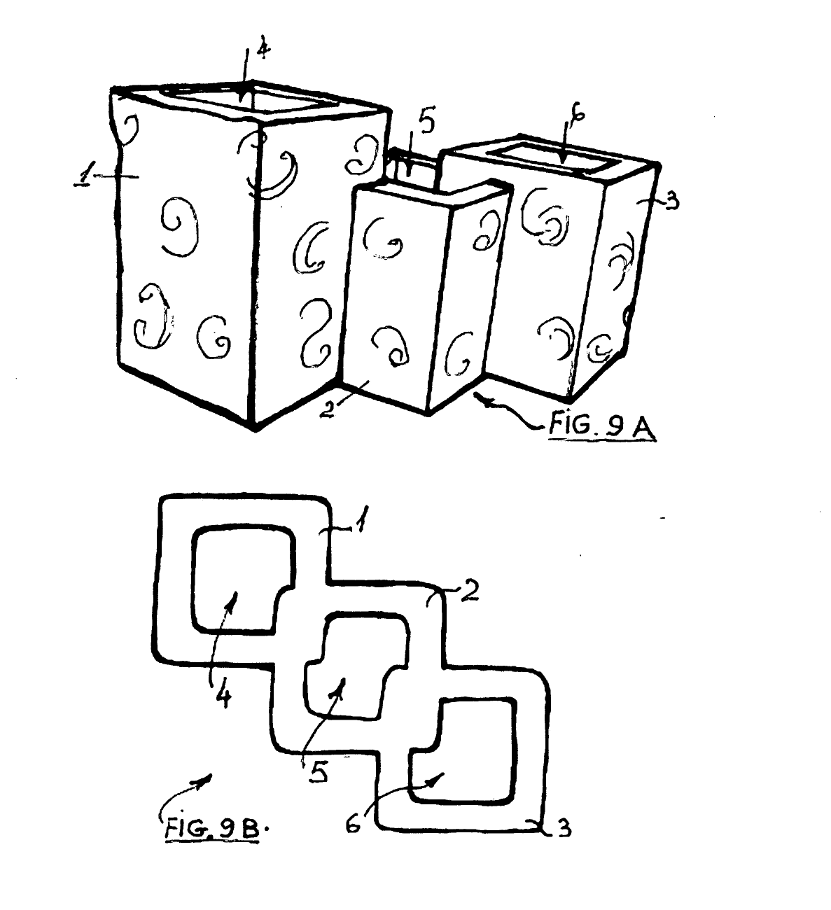

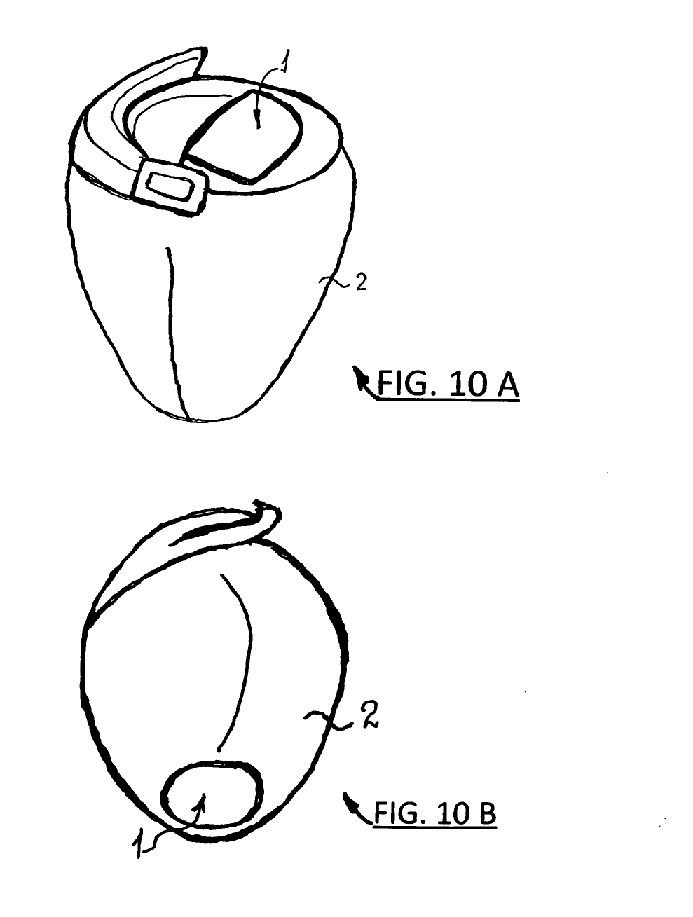

ROOTLESS POT prevents root bounding and does not require assembly. RP provides the root system of the plants, trees, bushes and/or other vegetation planted within its boundaries, unlimited freedom to grow and continuously expand while remaining undisturbed and in a potted like environment.

### BACKGROUND OF THE INVENTION

### U.S. Patent Documents

| | | |
|---|---|---|
| 579,993 | April 1897 | Mahler |
| 1,631,802 | June 1927 | Evert |
| 2,075,186 | March 1937 | Ellis |
| 2,253,817 | August 1941 | Simmons |
| 2,810,234 | October 1957 | Blackburn et al. |
| 2,814,427 | November 1957 | Emery |
| 3,009,603 | November 1961 | Stockdale |
| 3,027,684 | April 1962 | Keiding |
| 3,395,486 | August 1968 | Campbell et al. |
| 3,785,088 | January 1974 | Guarriello |
| 3,800,469 | April 1974 | Lau |
| D207174 | March 1967 | Rowbottam |
| | ;D35/3R,3A ;D29/28R | |
| | ;47/34R,34.11,34.13 | |
| | ;229/1.5B,3.5 | |

### U.S. Patent Documents

| | | |
|---|---|---|
| 1,775,831 | September 1930 | Salisbury |
| 3,696,987 | October 1972 | Schuff et al. |
| 3,800,469 | April 1974 | Lau, Jr. et al. |
| 3,896,587 | July 1975 | Insaloco |
| D233058 | October 1974 | Bufton |

### SUMMARY

ROOTLESS POT (RP); (ROOTLESS), is a bottomless single and/or multi chambered manufactured and/or artisan crafted pot and/or vase and/or planter that does not require assembly and prevents root bounding.

Standard planting pots and planters restrict the root system within its confined space causing the plant to become root bound, requiring the plant to be disturbed, replanted or repotted, in order to survive.

ROOTLESS POT prevents root bounding and does not require assembly, it's an entirely open interior bottom floor throughout ceiling and/or semi top ceiling/semi site(s) interior space, RP's free form and/or geometrically tubular based exterior and/or interior shaped design allows for an unrestricted passage and access to direct contact with the ground soil immediately underneath its domain.

Rootless provides the root system of the plants, trees, bushes and/or other vegetation planted within its boundaries, unlimited freedom to grow and continuously expand while remaining undisturbed and in a potted like environment.

### DETAILED DESCRIPTION OF THE INVENTION

ROOTLESS POT (RP); (ROOTLESS), is a multiple application, vegetation housing structure in a single and/or multi chambered, manufactured and/or artisan crafted, geometrical and/or free form tubular base shaped bottomless pot and/or vase and/or planter.

ROOTLESS POT prevents root bounding and does not require assembly.

Problems with previous art: Without the Rootless Pot, as plants outgrow their current pots the owner is faced with two choices, either allow the plant to be completely root bound and eventually perish, or re-pot the plant in a large pot which will result in the same scenario when the plant outgrows that pot, or in the ground losing the appeal of a potted plant.

Rootless Pot can be made in a various shapes and sizes and/or combinations of shapes and sizes including free form, for as long as it has at least one uninterruptedly connected and balanced to support its own weight, exterior wall, embodying geometrically tubular, and/or radially tubular and/or the various combinations existing in between the two general and all other existing shapes, not excluding free form, which may house additional tubular chambers individually and/or internally connected, where at least 2 or more inter tubular and/or inter connected and opposing each other and sharing the same tubular space large size openings, which also could be in any geometrical and/or free formed shapes (based on intended use and/or design), where at least 1 of the openings, per existing chamber, has to be in direct contact with the ground soil for the purpose to allow the root system of the vegetation, planted inside, an unrestricted passage to the ground soil below, when it's serving as a planter.

Designed with an open interior space from bottom to ceiling and/or semi ceiling and/or semi side(s), RP's free form and/or geometrically tubular based exterior and/or interior shaped design allows for an unrestricted passage and access to the ground soil immediately underneath its domain.

Standard planting pots and planters restrict the root system within its confined space causing the plant to become root bound, requiring the plant to be disturbed, replanted or repotted, in order to survive.

Rootless, provides the root system of the plants, trees, bushes and/or vegetation planted within its boundaries, close to unlimited freedom to grow and continuously expand while remaining undisturbed in a potted like environment.

ROOTLESS also guards the vegetation system by providing an extra level of protection from nature elements or human damage, and largely because of that the plants will remain healthier, especially during their early years.

Rootless Pot, can create an elegant green center and when positioned in a different perspective view it may serve as an abstract exhibiting center and/or: a seat; a bench; a table.

An additional benefit can be achieved by modifying the outside appearance so that individual Rootless Pots will conform and/or interlock with each other to create an abstract, and consistent in appearance, raised up wall.

ROOTLESS POT, could be made out of minimum of one material, or any and all water tight and/or water retaining, flexible and/or hard in consistency of their nature, natural and/or manmade materials that are capable of hardening into a consistent mold, including, but not limited to: glass, terracotta, ceramics, concrete, plastics, wood, metals or any combinations and/or blends of materials known to mankind, and/or yet to be discovered.

All colors and/or blend of colors could be used, including clear and white in the production of the Rootless Pot.

### METHODS

Different methods and even combinations of methods could be employed in producing RP:
By conceptually or digitally designing RP in a 3D program, such as MODO, followed by 3 dimensional printing using various technologies, additive processes and/or redacting methods as well as various materials and color combinations.
By hand, and/or with machinery tools
A ceramic like wheel could be used to assist (although not necessary) in creating, sculpting, carving of a vase shape tube or other geometrically based pots and/or vases and/or planters such as tubular 3 dimensional designs and sculptures when clay like moldable materials are used.
The Talavera process involves two firings. The first firing occurs at a little over 1550 degrees after which the items are applied with an under-glaze. The pieces are then decorated in the unique styles and patterns that are handed down through the generations and represent the beauty and fun of this style of pottery. The pottery is then fired a 2nd time at over 1900 degrees sealing the colors in a durable surface finish.
A metal and/or other clays could be sculpted and then baked in a kiln or an oven
By carving and/or drilling, this method could be used when working with natural stone and or large rock, such as marble or granite, a hole is drilled and/or carved through and through creating a free form tubular based Rootless Pot.
By using molds and/or injecting methods
By blowing glass methods
By stamping methods
By using rolling mills and soldering methods
   As technology advances farther, some more brilliant methods will be visible.

DIRECTIONAL USE: No Assembly Required
1. ROOTLESS POT already comes with a big hole, or holes, at its base . . . (Depending on design). Place it in the garden. Put your tree, plants, bushes and/or other vegetation and fill the rest of the space with soil, Water it, and now Rootless provides the root system of the plants, trees, bushes and/or other Vegetation planted within its boundaries, unlimited freedom to grow and Continuously expand while remaining undisturbed and in a potted like Environment. RP dresses up the plant and the garden.
2. ROOTLESS POT can create an elegant green center and when positioned in a Different perspective view (depending on design), it may serve as an abstract Exhibiting center and/or: a seat; a bench; a table.

### Page 1

ROOTLESS POT (RP); (ROOTLESS), is a bottomless single and/or multi chambered manufactured and/or artisan crafted pot and/or vase and/or planter that does not require assembly and prevents root bounding.

Standard planting pots and planters restrict the root system within its confined space causing the plant to become root bound, requiring the plant to be disturbed, replanted or repotted, in order to survive.

Problems with previous art: Without the Rootless Pot, as plants outgrow their current pots the owner is faced with two choices, either allow the plant to be completely root bound and eventually perish, or re-pot the plant in a large pot which will result in the same scenario when the plant outgrows that pot, or in the ground losing the appeal of a potted plant.

1. Rootless Pot prevents root bounding

2. Rootless Pot does not require assembly
ROOTLESS POT prevents root bounding and does not require assembly, it's an entirely open interior bottom floor throughout ceiling and/or semi top ceiling/semi site(s) interior space, RP's free form and/or geometrically tubular based exterior and/or interior shaped design allows for an unrestricted passage and access to direct contact with the ground soil immediately underneath its domain. Rootless provides the root system of the plants, trees, bushes and/or other vegetation planted within its boundaries, unlimited freedom to grow and continuously expand while remaining undisturbed and in a potted like environment.
ROOTLESS also guards the vegetation system by providing an extra level of protection from the elements, wildlife and/or human damage, and largely because of that, the plants will remain healthier, especially during their early years.
Rootless Pot, can create an elegant green center and, when positioned in a different perspective, it may serve as an abstract exhibiting center and/or a seat; a bench; a table.
An additional benefit can be achieved by modifying the outside appearance so that individual Rootless Pots will conform and/or interlock with each other to create an abstract, and consistent in appearance, raised up wall.
